(19) United States
(12) Patent Application Publication
(10) Pub. No.: US 2013/0341429 A1
(43) Pub. Date: Dec. 26, 2013

(54) PARTICLE DISPERSION DEVICE

(71) Applicant: SAMSUNG ELECTRO-MECHANICS CO., LTD., Suwon (KR)

(72) Inventor: Gi Ho HAN, Suwon (KR)

(73) Assignee: SAMSUNG ELECTRO-MECHANICS CO., LTD., Suwon (KR)

(21) Appl. No.: 13/826,677

(22) Filed: Mar. 14, 2013

(30) Foreign Application Priority Data
Jun. 26, 2012 (KR) 10-2012-0068614

(51) Int. Cl. B05B 7/14

(52) U.S. Cl. CPC B05B 7/1486
USPC 239/432; 239/499; 239/462

(57) ABSTRACT

The present invention relates to a particle dispersion device including: an injection unit for injecting particles; a chamber for preventing diffusion of the particles injected by the injection unit; and a dispersion unit formed inside the chamber to disperse the injected particles.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2012-0068614, entitled filed Jun. 26, 2012, which is hereby incorporated by reference in its entirety into this application.

### BACKGROUND OF THE INVENTION

1. Field of the Invention

The present invention relates to a particle dispersion device, and more particularly, to a particle dispersion device that can attach test particles to a test printed circuit board with uniform distribution during a test for defects caused by particles when manufacturing a printed circuit board.

2. Description of the Related Art

According to the development of electronics industry, there is a sharp increase in demand for printed circuit boards on which electronic components such as integrated circuits (IC) and large scale integration (LSI) ICs are mounted.

In general, a printed circuit board has been regarded as an essential component in almost all electronics industry related fields including information devices such as computers and mobile terminals as well as home electronics such as TVs, cameras, and VCRs. In recent times, circuit patterns of the printed circuit board become dense according to the demand for convergence between electronic devices and miniaturization and high functions of the electronic devices.

Here, the printed circuit boards (PCB) are largely classified into a flexible PCB and rigid PCB according to the rigidity of a substrate and classified into a single-sided PCB, a double-sided PCB, and a multilayer PCB according to the number of circuit pattern layers. In particular, as the products become smaller and thinner, the substrate of the PCB used in electronic packages becomes thinner. In order to implement various and complex functions in the thin structure, the substrate is generally manufactured in multiple layers.

A large number of particles such as fragments or dust remain in a manufacturing process of the printed circuit board.

For example, in a cutting process of cutting the printed circuit board or a perforating process of perforating the printed circuit board, burrs remain in a cut portion.

Due to this, the remaining various particles remain in various circuit patterns or contact portions of the printed circuit board in a backend process and can cause defects such as short or disconnection of the circuit pattern and malfunctions.

Further, as the circuit pattern becomes dense according to the miniaturization of the printed circuit board, the size of the particles, which can cause the defects such as short or disconnection of the circuit pattern of the printed circuit board, becomes smaller.

Accordingly, a device for testing a product impact on how much is a printed circuit board affected by the size or material of particles which cause defects in a manufacturing process of the printed circuit board is required, and a device for attaching particles to a printed circuit board for a product impact test is required.

### SUMMARY OF THE INVENTION

The present invention has been invented in order to overcome the above-described problems and it is, therefore, an object of the present invention to provide a particle dispersion device capable of attaching particles to a test printed circuit board for testing a product impact on particles that can cause defects in a manufacturing process of a printed circuit board with uniform distribution.

Further, it is another object of the present invention to provide a particle dispersion device that can be used in a narrow space, easily moved, and reduce manufacturing costs.

In accordance with one aspect of the present invention to achieve the object, there is provided a particle dispersion device including: an injection unit for injecting particles; a chamber for preventing diffusion of the particles injected by the injection unit; and a dispersion unit formed inside the chamber to disperse the injected particles.

Here, the dispersion unit may be formed in an upper portion of the chamber.

Further, the dispersion unit may include a dispersion plate against which the injected particles hit to be dispersed and a fixing bar for fixing the dispersion plate.

At this time, the dispersion plate may be concavely formed in a dish shape.

Further, the dispersion plate may be formed so that a concave surface thereof faces downward.

Meanwhile, a plurality of projections may be formed to project from a lower surface of the dispersion plate.

Meanwhile, the injection unit may include an air supply unit for supplying air, a particle storing unit connected to the air supply unit to store particles, an injection nozzle for injecting the particles, and a guide tube for guiding the particles injected from the injection nozzle to the chamber.

Here, the air supply unit may be a portable hand pump.

And, the guide tube may be formed so that one side thereof inserted into the chamber is bent upward.

Further, the injection unit may further include a filter for filtering the particles according to the size.

Meanwhile, a window may be formed on a lower surface of the chamber to discharge the particles.

In addition, a plurality of exhaust holes may be formed in the chamber to exhaust air.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view showing a particle dispersion device in accordance with an embodiment of the present invention;

FIG. 2 is a cross-sectional view showing a dispersion unit of FIG. 1;

FIGS. 3 and 4 are cross-sectional views showing another embodiment of the dispersion unit; and

FIG. 5 is a perspective view showing an operation of the particle dispersion device in accordance with an embodiment of the present invention.

### DETAILED DESCRIPTION OF THE PREFERABLE EMBODIMENTS

Hereinafter, specific embodiments of the present invention will be described with reference to the drawings. The following embodiments merely illustrate the present invention, and the present invention is not limited to the following embodiments.

In describing the present invention, specific descriptions of well-known techniques are omitted so as not to unnecessarily obscure the embodiments of the present invention. The following terms are defined in consideration of functions of the present invention and may be changed according to users or operator's intentions or customs. Thus, the terms shall be defined based on the contents described throughout the specification.

The technical sprit of the present invention should be defined by the attached claims, and the following embodiments are provided as examples to efficiently convey the technical spirit of the invention to those skilled in the art.

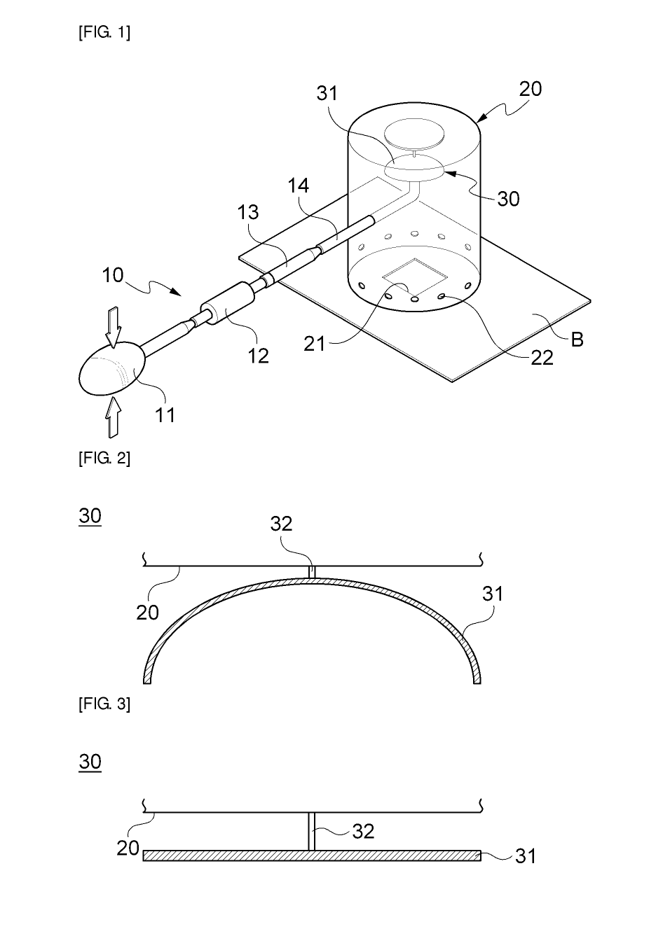

FIG. 1 is a perspective view showing a particle dispersion device in accordance with an embodiment of the present invention, and FIG. 2 is a cross-sectional view showing a dispersion unit of FIG. 1.

As shown in FIGS. 1 and 2, the particle dispersion device in accordance with an embodiment of the present invention is a device for attaching particles to a test printed circuit board during a product impact test for the size or material of particles that can cause defects in a manufacturing process of a printed circuit board and may include an injection unit 10 for injecting particles P, a chamber 20 for preventing diffusion of the particles P injected by the injection unit 10, and a dispersion unit 30 formed inside the chamber 20 to disperse the injected particles P.

The injection unit 10 injects the particles P and may consist of an air supply unit 11 for supplying air, a particle storing unit 12 connected to the air supply unit 11 to store the particles P, an injection nozzle 13 for injecting the particles P, and a guide tube 14 for guiding the particles P injected from the injection nozzle 13 to the chamber 20.

Here, the air supply unit 11, which supplies air, may supply compressed air for the injection of the particles P of the injection unit 10.

At this time, the air supply unit 11 may be a portable hand pump.

Further, it is preferred that the air supply unit 11 is a non-electric pump which does not use electric power.

In addition, the particle storing unit 12, which stores the particles P, is connected to the air supply unit 11 so that the supplied air is moved to the injection nozzle 13 with the particles P stored in the particle storing unit 12.

Here, it is preferred that the particle storing unit 12 stores the particles P of the same size, shape, or material.

That is, the particles P of the same size, shape, or material are injected to be attached to a test printed circuit board B during the injection of the particles P. Thus, it is possible to test a product impact on each of the size, shape, or material.

Meanwhile, the particles P, which are moved with the air supplied from the air supply unit 11, may be injected by the injection nozzle 13 connected to the particle storing unit 12.

Here, the guide tube 14 may be coupled with the injection nozzle 13 to guide the injected particles P to the chamber 20.

At this time, one side of the guide tube 14 may be connected to the injection nozzle 13, and the other side thereof may be inserted into the chamber 20. The other side of the guide tube 14 may be bent upward so that the particles P are injected into the following dispersion unit 30.

Further, the injection nozzle 13 and the guide tube 14 are formed to be separated and coupled and coupled with each other only during the injection of the particles P to guide the particles P to the chamber 20.

In addition, each of the air supply unit 11, the particle storing unit 12, the injection nozzle 13, and the guide tube 14, which constitute the injection unit 10, may be formed to be separated and assembled and configured in a small portable way to be used in a narrow space, easily moved, and reduce manufacturing costs.

Meanwhile, the injection unit 10 may further include a filter (not shown in the drawing) that can filter the particles P according to the size. At this time, the filter filters the particles P larger than a certain size so that the injection unit 10 injects the particles P of a uniform size to attach the particles P to the test printed circuit board B. Thus, it is possible to precisely test a product impact of a printed circuit board on the particles P.

The chamber 20, which prevents the diffusion of the particles P injected by the injection unit 10, may be formed in the shape of a cylinder having a space inside.

Here, the chamber 20 may be made of a transparent glass or acrylic material and formed in the shape of a polygonal pillar having a predetermined height as well as in the shape of a cylinder.

Further, a window 21 may be formed on a lower surface of the chamber 20.

At this time, the window 21 is formed by opening a portion of the lower surface of the chamber 20 to set an attachment region of the particles P in the test printed circuit board B to which the particles P are to be attached. Thus, it is possible to attach the particles P only to the test region in which the product impact test is performed without attaching the particles P to the entire test printed circuit board B.

In addition, a plurality of exhaust holes 22 may be formed on one side of a lower portion of the chamber 20.

Here, the exhaust hole 22 is formed in the lower portion of the chamber 20 to exhaust the air inside the chamber 20. Since the air supplied inside the chamber 20 with the particles P through the injection unit 10 is exhausted to the outside through the exhaust hole 22, a flow of an air current can be smooth from an upper portion to the lower portion of the chamber 20 and a flow of the particles P moving through the air current can be also smooth, thereby reducing the time required for attaching the particles P to the printed circuit board.

The dispersion unit 30 is formed in the inner upper portion of the chamber 20 to disperse the particles P injected by the injection unit 10 and may include a dispersion plate 31 against which the particles P injected by the injection unit 10 hit and a fixing bar 32 for fixing the dispersion plate 31.

Here, the dispersion plate 31 may be concavely formed in a dish shape and a concave surface thereof faces downward to be fixed to an inner upper surface of the chamber 20 by the fixing bar 32.

That is, the particles P injected by the injection unit 10 hit against a center portion of the dispersion plate 31 formed in a concave dish shape to be dispersed along the concave surface. Thus, the particles P are dispersed and attached to the test printed circuit board with uniform distribution.

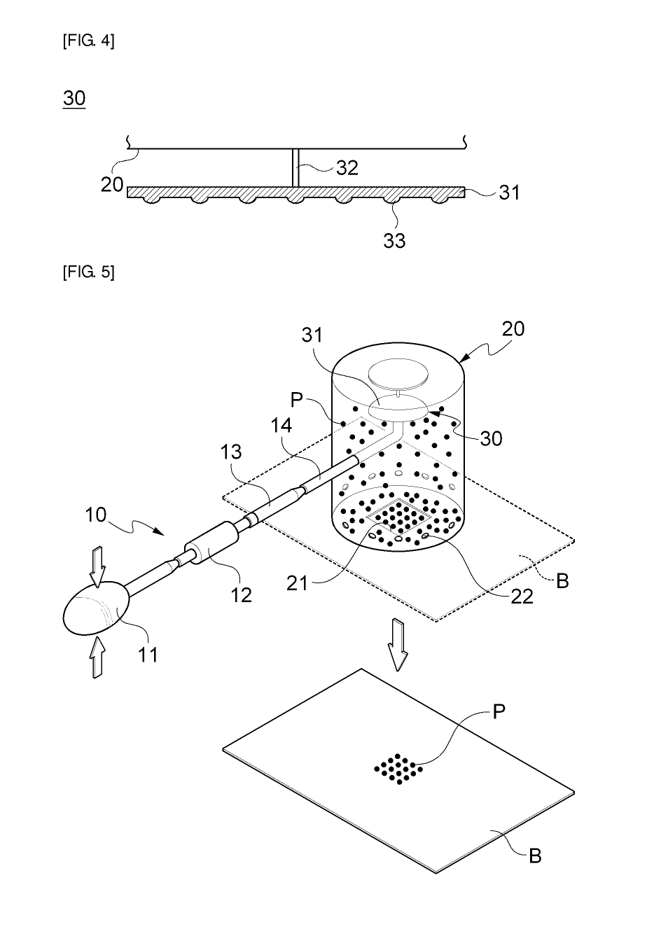

FIGS. 3 and 4 are cross-sectional views showing another embodiment of the dispersion unit.

The dispersion unit 30 of the present invention may be formed in various shapes as shown in FIGS. 3 and 4.

As shown in FIG. 3, the dispersion unit 30 may consist of a dispersion plate 31 which is formed in a flat plate shape and against which the particles P hit and a fixing bar 32 for fixing the dispersion plate 31 to the inner upper surface of the chamber 20.

Further, as shown in FIG. 4, the dispersion unit 30 may consist of a dispersion plate 31 against which the particles P hit, a fixing bar 32 for fixing the dispersion plate 31 to the inner upper surface of the chamber 20, and a projection 33 projecting from a lower surface of the dispersion plate 31.

At this time, the particles P hit against the projection 33 projecting from the lower surface of the dispersion plate 31 to be dispersed. Thus, the particles P are dispersed and attached to the test printed circuit board with uniform distribution.

FIG. 5 is a perspective view showing an operation of the particle dispersion device in accordance with an embodiment of the present invention.

The operation of the particle dispersion device configured as above will be described below with reference to FIG. 5.

First, the test printed circuit board B is disposed under the chamber 20 so that the particle P attachment region of the test printed circuit board B and the window 21 of the lower surface of the chamber 20 correspond to each other.

Next, the particle storing unit 12 stores a certain amount of the particles P of the same size, material, or shape, and the air supply unit 11 supplies air.

After that, the air supplied through the air supply unit 11 is injected by the injection nozzle 13 with the particles P stored in the particle storing unit 12, and the particles P injected by the injection nozzle 13 are introduced into the chamber 20 along the guide tube 14 connected to the injection nozzle 13 and injected toward the dispersion unit 30 formed on the inner upper surface of the chamber 20.

At this time, the guide tube 14 may be coupled with the injection nozzle 13 only during the injection of the particles P.

Next, the particles P injected toward the dispersion unit 30 hit against the center portion of the dispersion plate 31 formed in a concave dish shape to be dispersed along the concave surface.

After that, the dispersed particles P descend to a lower side of the chamber 20 by an air current generated when being hit, an air current generated when being exhausted through the exhaust hole 22 formed in the lower portion of the chamber 20, and gravitation applied to the particles P, and the particles P descended to the lower side of the chamber 22 pass through the window 31 to be attached to the particle P attachment region of the test printed circuit board B with uniform distribution.

Therefore, since the particle dispersion device in accordance with an embodiment of the present invention disperses the particles, which are injected by the injection unit and supplied to the chamber, using the dispersion plate, it is possible to attach the dispersed particles to the desired region of the test printed circuit board with uniform distribution. Further, since the particle dispersion device in accordance with an embodiment of the present invention is configured in a portable manner, it can be used in a narrow space, easily moved, and reduce manufacturing costs.

Although the present invention has been described in detail with reference to the preferable embodiments, it will be appreciated by those skilled in the art that various modifications may be made in these embodiments without departing from the scope of the present invention.

Therefore, the scope of the present invention should not be limited by the described embodiments but defined by the appended claims and their equivalents.

What is claimed is:

1. A particle dispersion device comprising:
an injection unit for injecting particles;
a chamber for preventing diffusion of the particles injected by the injection unit; and
a dispersion unit formed inside the chamber to disperse the injected particles.

2. The particle dispersion device according to claim 1, wherein the dispersion unit is formed in an upper portion of the chamber.

3. The particle dispersion device according to claim 1, wherein the dispersion unit comprises:
a dispersion plate against which the injected particles hit to be dispersed; and
a fixing bar for fixing the dispersion plate.

4. The particle dispersion device according to claim 3, wherein the dispersion plate is concavely formed in a dish shape.

5. The particle dispersion device according to claim 4, wherein the dispersion plate is formed so that a concave surface thereof faces downward.

6. The particle dispersion device according to claim 3, wherein a plurality of projections are formed to project from a lower surface of the dispersion plate.

7. The particle dispersion device according to claim 1, wherein the injection unit comprises:
an air supply unit for supplying air;
a particle storing unit connected to the air supply unit to store particles;
an injection nozzle for injecting the particles; and
a guide tube for guiding the particles injected from the injection nozzle to the chamber.

8. The particle dispersion device according to claim 7, wherein the air supply unit is a portable hand pump.

9. The particle dispersion device according to claim 7, wherein the guide tube is formed so that one side thereof inserted into the chamber is bent upward.

10. The particle dispersion device according to claim 1, wherein the injection unit further comprises a filter for filtering the particles according to the size.

11. The particle dispersion device according to claim 1, wherein a window is formed on a lower surface of the chamber to discharge the particles.

12. The particle dispersion device according to claim 1, wherein a plurality of exhaust holes are formed in the chamber to exhaust air.
